(19) United States
(12) Patent Application Publication
(10) Pub. No.: US 2002/0007583 A1
(43) Pub. Date: Jan. 24, 2002

(54) Fishing lure with convertible blade for varying action of lure

(76) Inventor: Thomas B. Nelson, Alexandria, VA (US)

Correspondence Address: SHLESINGER, ARKWRIGHT & GARVEY LLP, PATENT, TRADEMARK & COPYRIGHT LAW, 3000 SOUTH EADS STREET, ARLINGTON, VA, 22202, US

(21) Appl. No.: 09/905,860

(22) Filed: Jul. 17, 2001

Related U.S. Application Data
(60) Provisional application No. 60/218,533, filed on Jul. 17, 2000.

(51) Int. Cl. A01K 85/00

(52) U.S. Cl. 43/42.09

(57) ABSTRACT

Fish lure system includes a body and at least two diving and moving elements. One of the diving and moving elements is attached to said lure for causing said lure to exhibit a first diving and moving behavior when it is attached to said lure. The lure exhibits a second diving and moving behavior differing from the first diving and moving behavior, when the second diving and moving elements is attached to the lure in place of the first diving and moving elements.

### CROSS REFERENCE TO RELATED APPLICATION

This application claims the priority of U.S. Provisional Application No. 60/218,533, filed Jul. 17, 2000, and which is incorporated herein by reference.

### FIELD OF THE INVENTION

The invention relates to fishing equipment and methods of using such. More specifically, the invention relates to fishing lures and methods of using such lures. Even more specifically, the invention relates to fishing lures capable of exhibiting selectively variable movements while being used to attract fish, so as to enhance the attractiveness of the lure to the game fish, as well as to provide for a single lure, for example, capable of various behaviors depending on the fisher's or angler's requirements.

### BACKGROUND OF THE INVENTION

Fishing lures have been known for many generations.

Known fishing lures includes lures having attractants including pieces of animal feathers and fur for exhibiting the appearance of insects, such as flies.

There have also been lures previously made which include blades or spoons for causing the lure to dive or move deeper into the water as the lure is pulled along by the line to which it is attached and by which the lure is controlled by the fisher.

However, the problem still remains that each known lure is dedicated to a particular purpose. For example, there are hundreds of known “flies” for attracting top-feeding or surface-feeding fish.

Known diving lures dedicated to exhibiting a specific behavior have likewise been made.

Accordingly, there is a need to provide a fishing lure which is more versatile than known lures.

### OBJECTS AND SUMMARY OF THE INVENTION

Accordingly, it is an object of the invention to overcome the drawbacks of the prior art lures.

Another object of the invention is to provide a lure which can provide one or more diving or “swimming” behaviors in the water, in use, without the need for a specific lure dedicated to each desired diving or swimming behavior.

A further object of the invention is to provide a lure which may be readily converted from one type of diving or swimming behavior to another.

Yet another object of the invention is to provide a lure system which either provides for two(2) dedicated lures exhibiting predetermined characteristics or replaces the need for two(2) or more dedicated lures, thereby increasing space available in a fisher's tackle box, as well as being more cost efficient and using fewer materials, and, hence, fewer natural resources.

In summary, the invention is directed to a fishing lure system which provides lures that can exhibit multiple diving or swimming behaviors.

The invention is likewise directed to a fishing lure or lure system which has two(2) or more discrete diving or swimming behaviors, and which lure can be readily switched over or converted from a first diving behavior to a second diving behavior.

The invention is likewise directed to a method of readily converting a fishing lure from a first diving behavior to a second diving behavior (e.g., by switching from a first blade to a second blade).

It should be noted that relative terms such as up, down, left, and right are for convenience only and are not intended to be limiting.

### BRIEF DESCRIPTION OF THE DRAWINGS

FIG. 1 is a side elevational view of a fishing lure according to a first preferred embodiment of the invention;

FIG. 2 is a lower perspective view of a portion of the preferred embodiment of FIG. 1;

FIG. 3 is a top plan view of a first preferred embodiment of a blade according to the invention that has been shown and installed in the lure of FIG. 1;

FIG. 4 is a top plan view, similar to FIG. 3, of a further preferred embodiment of a blade according to the invention;

FIG. 5 is a side elevational view of the preferred embodiment of the blade of FIG. 4;

FIG. 6 is a side elevational view of a fishing lure according to a further preferred embodiment of the invention;

FIG. 7 is a lower perspective view of a portion of the preferred embodiment of FIG. 6;

FIG. 8 is a top plan view of the preferred embodiment of a blade according to the invention that has been shown and installed in the lure of FIG. 6;

FIG. 9 is a top plan view, similar to FIG. 8, of another preferred embodiment of a blade according to the invention; and

FIG. 10 is a side elevational view of the preferred embodiment of the blade of FIG. 9.

### DETAILED DESCRIPTION OF THE INVENTION

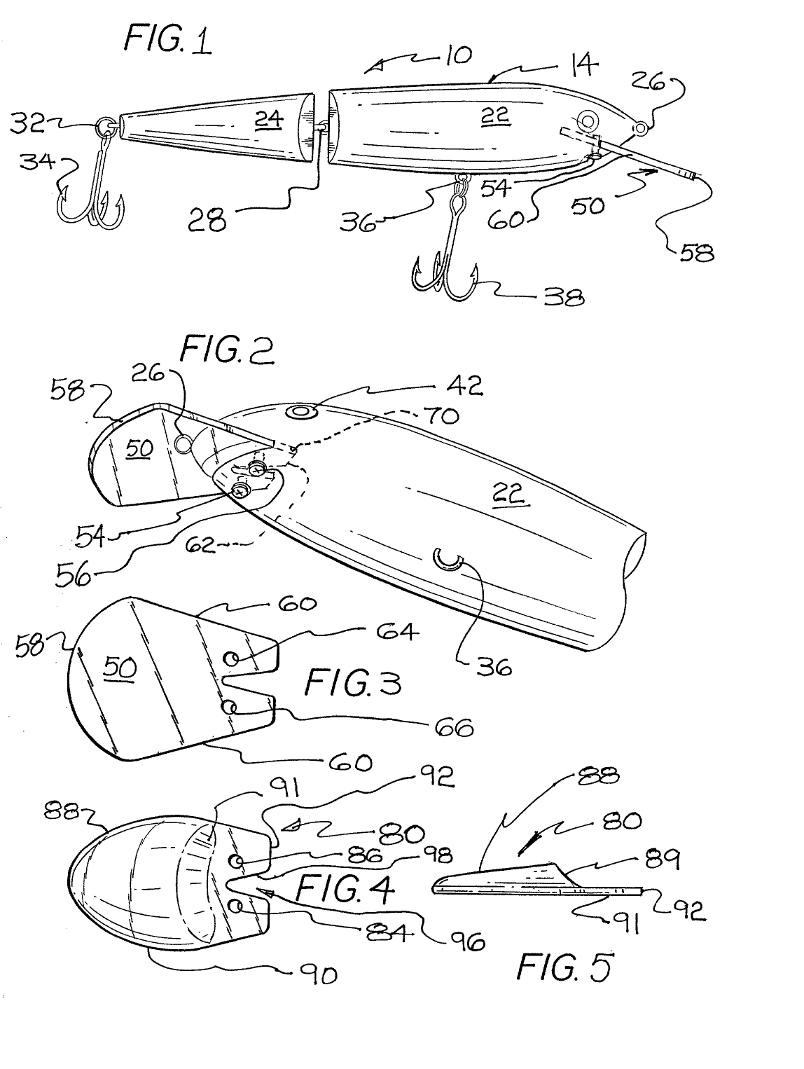

FIGS. 1-5 illustrate a first preferred embodiment of a fish lure 10 according to the invention.

Fish lure 10 includes a body 14 having a front portion 22 and a rear portion 24. A forwardmost connector or eye 26 may be provided for receiving a fishing line attached thereto.

Rear portion 24 may be movably connected to front portion 22 by a connector 28, such as the illustrated swivel.

A rear attachment element or eye 32 may be provided for securing a rear hook 34 to rear portion 24.

A forward connector or eye 36 may likewise be provided on front portion 22 for securing a forward hook 38 thereto.

Hooks 34 and 38 may be conventional three-prong hooks, for example.

Lure 10 may include a pattern 42, such as the illustrated eye, as well as coloration or camouflage, for example. The coloration may be selected depending on the type of fish for which one is fishing as will be readily appreciated.

A diving control element 50, such as a blade or spoon may be provided on front portion 22.

Good results have been achieved when blade 50 is detachably attached to front portion 22 by use of fasteners 54 and 56. Fasteners 54 and 56 may be removable fasteners, such as the illustrated screws.

Blade 50 may be substantially flat, as illustrated.

Blade 50 will be used when the fisher wants to have the lure 10 run at a depth of about 2 —5 feet below the surface of the water, when the user is trolling at the speed of about 3 —4 miles per hour (m.p.h.).

FIG. 2 illustrates that blade 50 may have a rounded configuration at a front portion 58.

One or both of illustrated sides 60 may be substantially straight and extend inwardly rearwardly toward a rear portion 62 of blade 50. One or more holes 64 and 66 may be provided to receive respective fasteners 54 and 56.

FIGS. 4 and 5 illustrate a further preferred embodiment of a blade 80 according to the invention.

Blade 80 may include a first hole 84 and a second hole 86.

A front 88 of blade 80 curves outwardly and downwardly, as illustrated, toward a middle region 89.

One or more sides 90 may likewise be somewhat curved.

Middle region 89 terminates and extends in a flat region 91 extending between middle region 89 and a rear 92.

As will be readily appreciated, flat region 91 includes a portion which will be disposed within the blade receiving opening 70 of lure 10.

Thus, when installed, flat region 91 will be at least partially installed within blade receiving opening or recess 70.

In use, blade 80 will be installed so that the curved portion faces downwardly away from front fishing line connector 26, for example.

Blade 80 may be termed a scooped blade and has been engineered to run at a depth of about 4 —10 feet when trolling at a speed of about 3 —4 miles per hour (m.p.h.). Blade 80 has been developed to run among all types of structures.

Scooped blade 80 is typically configured for running at a deeper depth than substantially flat blade 50.

An alignment element 96 or removed portion may be provided at rear 92 of blade 80. One or more sides 98 of alignment element 96 may be configured to engage with substantially correspondingly shaped male portions of lure 10. In that manner, blade 80 is further secured in place relative to front portion 22 of lure 10.

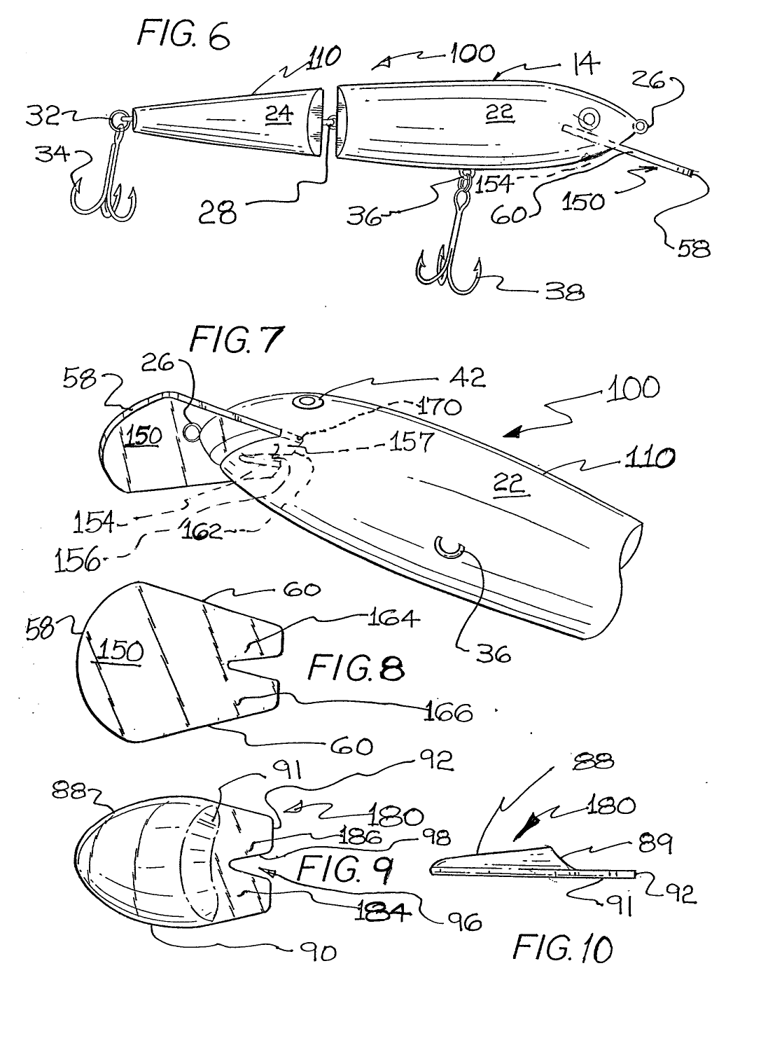

FIGS. 6-10 illustrate another preferred embodiment of a fish lure system 100 according to the invention.

Fish lure system 100 has many components which are similar to fish lure 10 of FIGS. 1-5.

Fish lure system 100 includes, typically, two(2) or more fish lures having blades which are fixed blades.

The like components of the embodiments of FIGS. 6-10 have like reference numerals as in the embodiment of FIGS. 1-5. Different components are represented by different reference numerals, needless to say.

In short, fish lure system 100 includes two(2) fish lures, each having fixed blades. A first fish lure 110 is shown in FIGS. 6-8. Fish lure 110 includes a flat blade or diving control element 150 that may be fixedly attached to fish lure 110.

In a manner similar to diving control element 50 of fish lure 10 of FIGS. 1-5, blade 150 is used for causing the fish lure 110 to run at a first depth of about 4-10 feet when trolling at a speed of about 3-4 miles per hour (m.p.h.).

Flat blade 150 may be provided with regions 154 and 156 adjacent a rear portion 162 of blade 50. Regions 154 and 156 are used for securing blade 150 to fish lure 110.

In the case where blade 150 is to be fixedly attached to the remainder of fish lure 110, an adhesive may be provided in a vicinity of regions 154 and 156. For example, adhesive may be inserted into or provided in the counterpart opening 170 which receives regions 154 and 156. The glue or adhesive will be spread and will contact regions 154 and 156, based on the selected tolerances between the size of blade receiving opening 170.

In a like manner, adhesive receiving portions 184 and 186 may be provided on a blade 180 that has a rounded configuration.

Blade 180 may be configured substantially the same as blade 80 of FIGS. 1-5, yet without the provision of holes 84 and 86 therein. 162 refers to the end of blade 150 which is inserted into blade receiving hole 170.

Of course, as will be readily appreciated, regions 184 and 186 may be adhered to a respective unillustrated fish lure instead of regions 154 and 156 when blade 180 is used for controlling the trolling depths of the associated lure.

It will be appreciated that, instead of adhering a blade to the body of a fish lure with an adhesive, such as epoxy, glue, and the like, the blades may be fixedly attached to the body by use of rivets, or 1-way fasteners that can only be installed and cannot be removed, instead of the fasteners 54 and 56 of the embodiment of FIGS. 1-5, for example.

The use of adhesives and non-removable fasteners are but two(2) examples of the manner in which the blades may be attached to the remainder of the fish lure.

The entire fish lure may be made as an integral whole.

### OPERATION

In use, the fisher ties the fishing line to front connector 26.

In the case where the desired one of blade 50 and 80 is already installed on lure 10, the user simply begins to fish drawing the lure 10 through the water at the desired speed to achieve the desired depth.

If blade 50 had been installed, and the user wants to switch to blade 80, for example, the user removes fasteners 54 and 56, such as by unscrewing the fasteners in the case where screws are used.

After fasteners 54 and 56 have been removed, blade 50 is moved outwardly away from body 22. Blade 80 is then inserted with the rounded portion at front 80 installed facing downwardly. When holes 84 and 86 are aligned with the respective corresponding holes in lure 10, fasteners 54 and 56 are inserted into their respective holes and secured.

The fisher may then fish again at the desired speed and depth.

It is expected that any conventional materials be used for making the lure, the blades, the hooks, and the like.

Preferably, the blades are made of clear colorless material, such as transparent plastic free of colorants.

As to coloration or camouflage of lure 10, typical colorations may include a lure being substantially all orange, substantially green with or without patterns to make the lure appear to be a fish, and a white-orange lure with yellow stripes on the side.

Preferred number of hooks is two(2).

The jointed design; i.e., the jointing or swivel connector being front and rear portions 22 and 24 of lure 10 is preferred.

The lure is particularly suited for attracting Big Northern Pike and Muskellunge. Good results have been achieved in fishing for these two(2) fish species during secret tests performed in the Great Lakes region of the United States.

The lures may be made of any length. Good results have been achieved when the length of the lures are nine(9) inches (about 23 centimeters) and twelve(12) inches (about 30 centimeters) in length.

Good results have been achieved when lures of the illustrated type have been made jointed when both flat and scooped (outwardly curved) blades have been used.

The illustrated convertible blade option offers one basic action with two(2) possible depth levels. Other options of lure movements and depth levels are contemplated.

Good results have been achieved when relatively large hooks, such as standard #5 or #6 hooks have been used, as opposed to the conventionally provided #3 #4 hooks sold on the majority of Muskellunge lures sold in the United States.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

Claims:

1. A fish lure system, comprising:
a) a body; and
b) at least two diving and moving elements, at least one of the diving and moving elements being attached to said lure for causing said lure to exhibit a first diving and moving behavior when said one of said at least two diving and moving elements is attached to said lure, and said lure exhibiting a second diving and moving behavior differing from the first diving and moving behavior, when a second one of the at least two diving and moving elements is attached to the lure in place of the first one of the at least two diving and moving elements.

2. A lure as in claim 1, wherein:
a) said first diving and moving element includes a blade detachably attached to a front portion of said lure.

3. A lure as in claim 2, wherein:
a) said blade is substantially flat.

4. A lure as in claim 3, wherein:
a) said second diving and moving element has an outwardly rounded portion.

5. A lure as defined in claim 4, wherein:
a) said flat blade is configured for causing said lure to dive to and travel at a first depth under the surface of a body of water when the lure is traveling at a first speed through the body of water, and the second diving and moving element includes a blade configured for causing the lure to travel at a second depth below the surface of the body of water when traveling at the same rate of speed through the body of water, the second depth differing from the first depth.

6. A lure as defined in claim 5, wherein:
a) the first blade is substantially completely flat.

7. A lure as defined in claim 5, wherein:
a) the second blade is outwardly rounded.

8. A lure as defined in claim 7, wherein:
a) the first and second blades are fixedly attached to the lure by a fastener.

9. A lure as defined in claim 8, wherein:
a) the fastener includes a screw.

10. A lure as defined in claim 9, wherein:
a) the screw includes a pair of screws.

11. A fishing lure system, comprising:
a) a body;
b) a first blade having a configuration and being attachable to said body; and
c) a second blade, said second blade having a configuration differing from the configuration of said first blade and being attachable to said body when said first blade is not attached to said body.

12. A system as defined in claim 11, wherein:
a) said first blade is substantially flat and said second blade includes an outwardly rounded portion.

13. A method of fishing at different depths relative to the surface of a body of water while trolling at a substantially constant speed, the method comprising:
a) providing a fish lure;
b) providing a first depth determining element;
c) providing a second depth determining element; and
d) attaching said first depth determining element to said fish lure for causing said fish lure to travel at a depth differing from the depth determined by the second depth determining element when the second depth determining element is installed on the fish lure.

14. A method as in claim 13, wherein:
a) in said step of attaching said first depth determining element to said fish lure, said second depth determining element is fixedly attached to said fish lure.

15. A fish lure system as in claim 1, wherein:
a) said at least one of the diving and moving elements being fixedly attached to said lure.

16. A fish lure system as in claim 1, wherein:
a) said at least one of the diving and moving elements is detachably attached to said lure.

17. A fish lure system as in claim 15, wherein:
a) said at least one of the diving and moving elements is fixedly attached to said lure with an adhesive.

18. A fish lure system as in claim 15, wherein:
a) said at least one of the diving and moving elements is fixedly attached to said lure with an fastener.
